(19) United States
(12) Patent Application Publication
(10) Pub. No.: US 2005/0275254 A1
(43) Pub. Date: Dec. 15, 2005

(54) Bicycle seat adapter

(76) Inventors: Ty Anderson, Maple Ridge (CA); Garnett RyShak, Port Moody (CA)

Correspondence Address: Clifford W. Vermette;Vermette & Co., Suite 230-200 Granville Street, Box 40 Granville Square, Vancouver, BC, V6C 1S4, CA

(21) Appl. No.: 10/865,855

(22) Filed: Jun. 14, 2004

(51) Int. Cl. B62J 1/00; B60N 2/38

(52) U.S. Cl. 297/195.1

(57) ABSTRACT

A bicycle seat adapter (68) for mounting a bicycle seat to a bicycle having a seatpost element. The bicycle seat adapter (68) has a seat mounted to a hollow seat tube (60) operative to receive therein the seatpost element. The hollow seat tube (60) has a clamp (66) operative to compress the hollow seat tube (60) about the seatpost element. The seat post element can be the pump (10) described herein, a conventional seatpost, an integral part of the bicycle frame, or other object.

### FIELD

The present invention relates to a bicycle pump that is used as a seatpost on a bicycle and a bicycle seat adapter for use therewith.

### BACKGROUND

Conventional bicycle pumps are typically mounted with brackets on the bicycle frame. It is not unusual for the hand pump to fall off when the cyclist goes over rough road. The relative heaviness of the hand pump as compared with the flexibility of many plastic frame mounts makes it difficult for the plastic frame mounts to retain the pumps once they acquire momentum. An additional problem is the limited amount of space on modern bicycles in which to mount the hand pump.

Accordingly, it is an object of the present invention to provide a bicycle hand pump, which can function as a seatpost. It is a further object of this invention to provide a bicycle seat adapter that enables a bicycle seat to be mounted to said hand pump.

### SUMMARY OF THE INVENTION

According to the invention there is provided a bicycle pump for inflating tires of a bicycle, which comprises a short barrel having an elongated tube affixed thereto, and an elongated barrel having a hollow interior, into which the elongated tube slides. The elongated barrel is slidably insertable into a hollow frame element of the bicycle, and is adapted to be clamped and used as a seatpost.

Preferably, the elongated tube has male threads adjacent an engaging end of the short barrel, which faces an engaging end of the elongated barrel. An engaging end of the elongated barrel has female threads, which receive and register with the male threads of the elongated tube so as to hold the short barrel in abutting relationship with the elongated barrel.

Advantageously, the elongated barrel has a storage chamber for storing tire patches and a bicycle tire adapter operative to detachably couple to an end of the short barrel at one end and to a bicycle tire valve at another end.

In another aspect of the invention there is provided a method of carrying a bicycle pump on a bicycle, comprising forming an outside diameter of the bicycle pump such that it is slidably insertable into a seatpost receiving frame element of the bicycle, clamping the pump to the seatpost receiving frame element, and clamping a bicycle seat to a top end of the pump.

By utilizing the pump as a seat post the need to mount it along a frame element with clamps is avoided. Often such mountings fail when traversing rough terrain and the pump is either lost or the cyclist must stop and return to pick up the pump. In addition, valuable space is taken up which could be used for mounting such items as water bottles and the like. A storage space in the pump allows for storage of the pump-to-tire valve adapter and the tire patches. Other items such as jewelry and pens can also be stored.

In yet another aspect of the invention there is provided a bicycle seat adapter for mounting a bicycle seat to a bicycle having a seatpost element. The bicycle seat adapter has a seat mounted to a hollow seat tube operative to receive therein the seatpost element. The hollow seat tube has a clamp operative to compress the hollow seat tube about the seatpost element. The seat post element can be the pump described herein, a conventional seatpost, an integral part of the bicycle frame, or other object.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a side elevation view of the pump in a closed position;

FIG. 2 is a side elevation view of the pump with the piston withdrawn;

FIG. 3 is a a side elevation view partly in section with the piston withdrawn;

FIG. 4 is a side elevation view of a bicycle with the seatpost of the present invention in place;

FIG. 5 is a perspective view of a nut with threadedly closes an end of the pump;

FIG. 6 is a side view of a coupler, which couples the end of the pump to a valve of a bicycle tube;

FIG. 7 is a side view of bicycle seat adapter mounted on the pump; and

FIG. 8 is a bottom view of the bicycle seat adapter.

### DETAILED DESCRIPTION WITH REFERENCE TO THE DRAWINGS

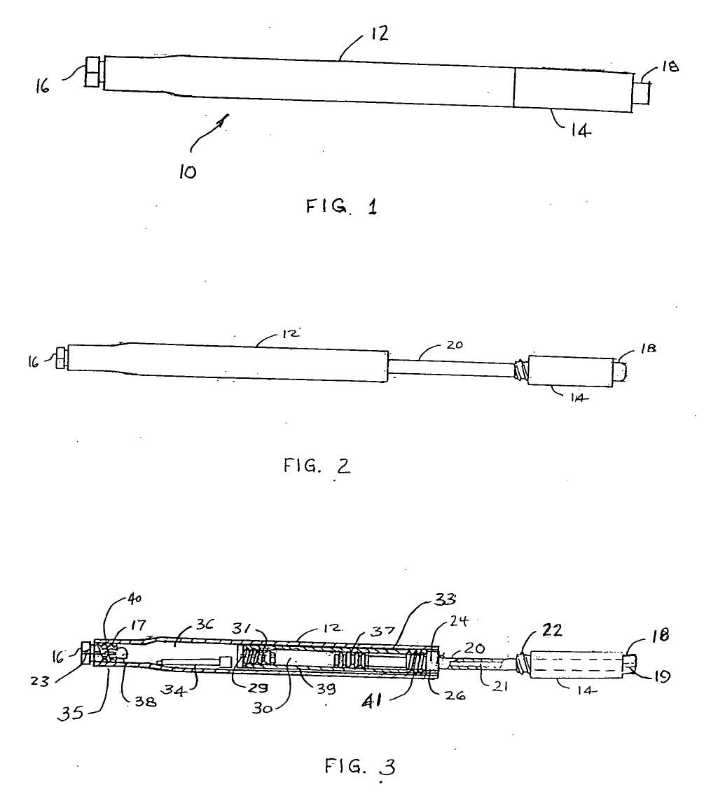

Referring to FIGS. 1, 2 and 3 the bicycle pump 10 has a elongated barrel 12 with a nut 16 that screws into one end and a short barrel 14 having nozzle 18 with a threaded hole 19. Short barrel 14 slides into elongated barrel 12 with compressed air escaping from nozzle 18.

Referring to FIG. 3, elongated barrel 12 is hollow and has a slightly narrowed end 35 having interior threads which register with threads 17 to hold a nut 16 in place. Nut 16 has a bore 23 there through and a receptacle in its end to hold tire patches 38. Nut 16 provides fluid communication with an interior of the elongated barrel 12. A second cylinder 33 is slidably insertable in close fitting engagement into elongated barrel 12. A plug 26 has threads 41, which are threaded into threads in an end of the second cylinder 33. A plug 24 fits snugly into an interior of elongated barrel 12. A short barrel 14 has a hollow elongated tube 20 passing centrally there through to an end thereof. Another end of tube 20 slidably passes through plug 24. A seal 37 made up of four spaced apart o-rings is mounted over a distal end of tube 20 and seals against an interior surface of the second cylinder 33. An end of the second cylinder 33 inside the elongated barrel 12 has a threaded one-way valve 31 with a passageway 29 there through.

Adjacent the second cylinder 33 is a storage space 36, which carries a bicycle tire valve adapter 34 and tire patches 38. It can also carry such items as keys and small valuables (not shown). Tube 20, which is affixed to short barrel 14, has a hollow interior 21, which is in fluid communication with threaded opening 19. A bushing 26 is threaded in head 24. When tube 20 is pushed into elongated barrel 12, threads 22 contact the threads of bushing 26. Upon rotating short barrel clockwise, male threads 22 engage female threads in bushing 26 pulling the short barrel 14 into abutment with elongated barrel 12.

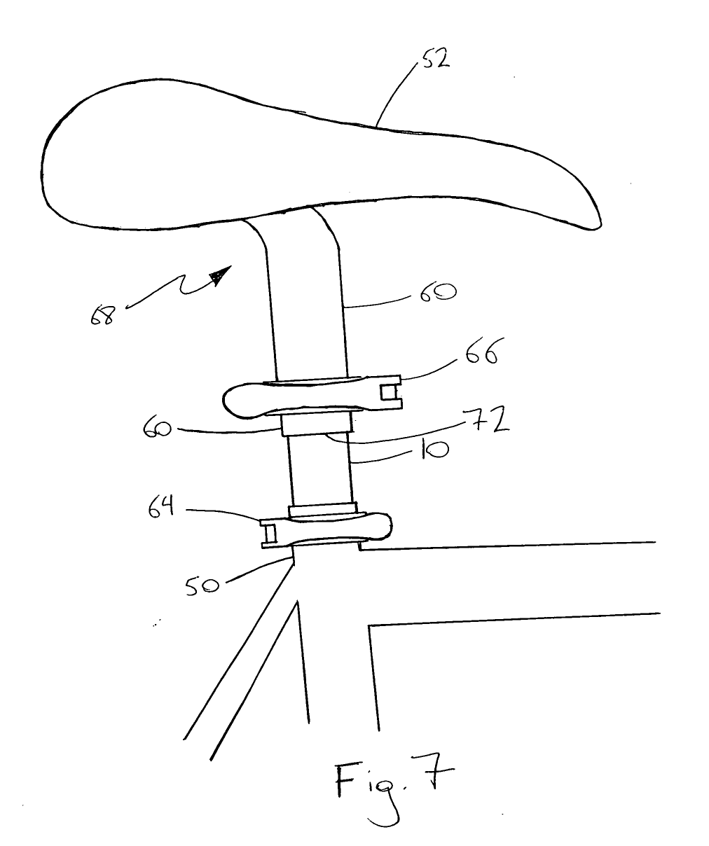

Storage chamber 36 is closed by a large nut 16 (see FIG. 5) having threads 40 which register with threads 17 on the interior surface of an end of long barrel 12. Nut 16 has a hollow end 41 (see FIG. 5), which carries the bicycle tire patches 38. The bicycle tire adapter 34 (see FIG. 6), which is stored in storage chamber 36, has a threaded end 42, that screws into the threaded opening 19 in nut 18. Threaded opening 19 is in fluid communication with hollow interior 21 of tube 20. One end of the adapter 34 has a female coupling 44 which screws onto a valve on a bicycle tire (not shown). A flexible tube 43 interconnects threaded end 42 with female coupling end 44.

In operation, storage chamber 36 is at atmospheric pressure and O-rings 37 are positioned adjacent one-way valve 31. As elongated barrel 12 is moved away from short barrel 14, O-rings 37 on tube 20 move to the right in pumping chamber 30 creating a lowered pressure in the chamber 30. Air then flows through hole 23, through storage chamber 36, through opening 29 in one-way valve 31 and into pumping chamber 30, filling up pumping chamber 30 with air. With the O-rings 37 abutting the bushing 26, short barrel 14 is then moved in an opposite direction so that O-rings 37 move towards one-way valve 31. The latter valve does not permit air to travel through it into storage chamber 36. The air is forced along hollow interior 21 of tube 20 and out through opening 19.

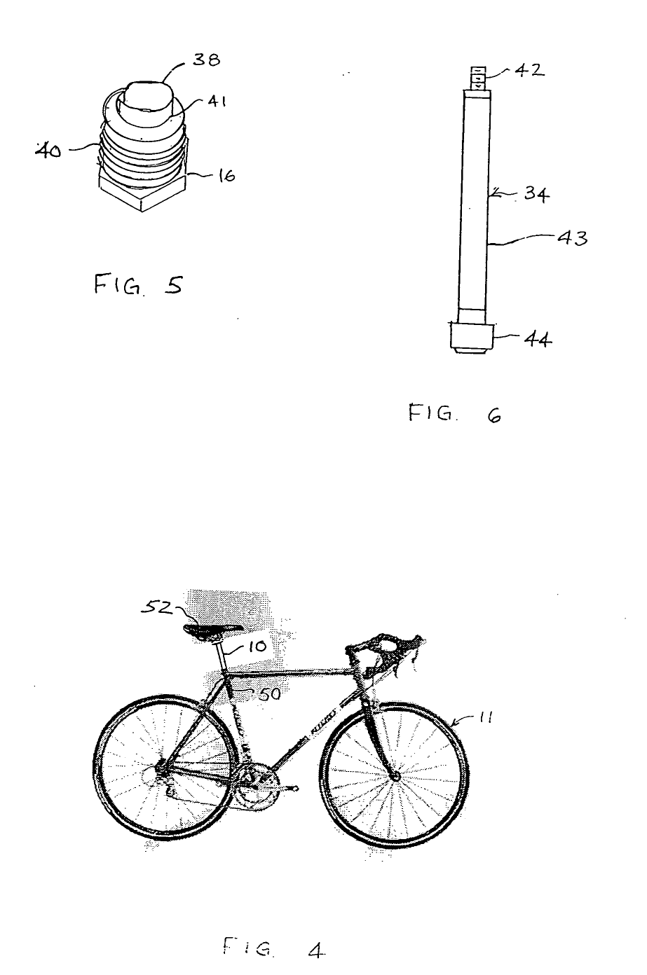

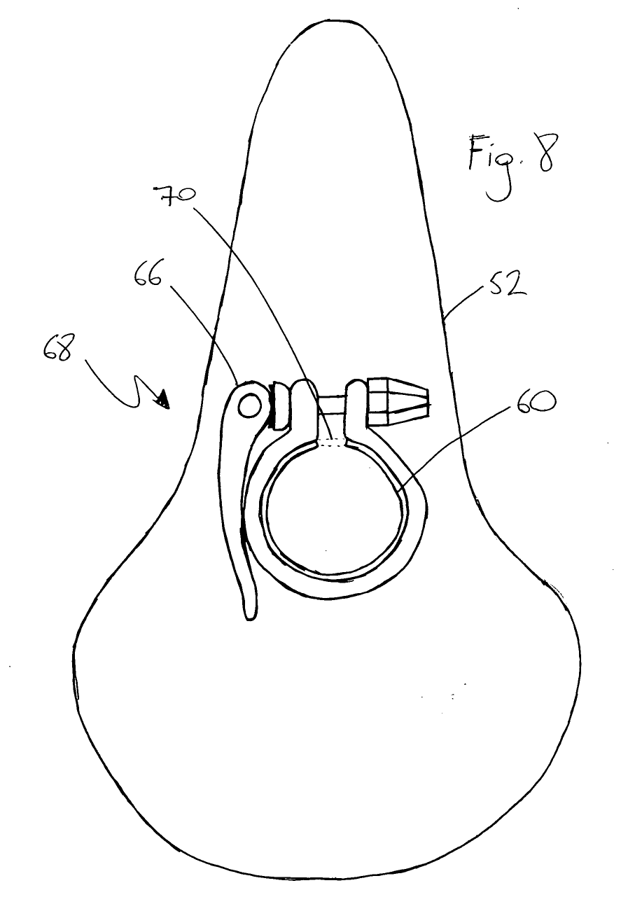

Pump 10, when assembled as shown in FIGS. 1, 2 and 3, is placed into hollow bicycle frame element 50, (see FIGS. 4 and 7) positioned at a desired height, and then locked with a standard seatpost clamp (see 64 in FIG. 7). The outside diameter of elongated barrel 12 and short barrel 14 of the pump 10 are selected to be marginally less than the inside diameter of the hollow bicycle frame element 50. The latter inside diameter is the same in approximately 80% or more of the bicycles in use. Clamp shims (not shown) may be used if necessary to adapt the size of the pump 10 to the inside diameter of the hollow frame element 50.

Conventional prior art bicycle seats are mounted to seatposts that slide into the frame of the bicycle. However, referring to FIGS. 4, 7 and 8, the present invention contemplates a bike seat adapter 68 having a seat 52, a hollow seat tube 60 that slides over the end of the pump 10, and a quick release clamp 66. In the preferred embodiment the quick release clamp 66 is an integral part of the hollow seat tube 60. The seat 52 may be removably or permanently attached to the hollow seat tube 60 by means known in the prior art.

The hollow seatpost 60 slides over the pump 10 and is fixed to a top end of the pump 10 by closure of the quick release clamp 66. The pump 10 is in turn fixed relative to the bicycle frame element 50 by a clamp 64. The inside diameter of the hollow seat tube 60 is marginally more than the outside diameter of the short barrel 14 and elongated barrel 12 of the pump 10.

It will be readily apparent to those skilled in the art that the hollow seat tube 60 of the bicycle seat adapter 68 could also slidably receive a conventional seatpost or other cylindrical element that functions as a seatpost.

Referring to FIGS. 7 and 8, the hollow seat tube 60 has a slot 70 running from the bottom edge 72 of the hollow seat tube 60 in an upward direction parallel to the longitudinal axis of the hollow seat tube 60. The slot 70 allows for compression of the hollow seat tube 60 around the pump 10 when the quick release clamp 66 is closed.

Referring to FIGS. 3, 5, 6, and 7, when a rider has a flat tire, the bike seat adapter 68 is released from the pump 10 by opening the quick release clamp 66 and sliding the hollow seat tube 60 off of the pump 10. Then the clamp 64 on the bicycle frame element 50 is released to allow the pump 10 to be removed from the hollow frame element 50. Nut 16 is unscrewed and both the patches 38 and the adapter 34 are removed once the bicycle tire 11 has been patched, the end 44 of adapter 43 is screwed onto the bicycle wheel valve (not shown) and the other end is screwed into threaded opening 19 of the pump 10. The pump 10 is operated by, alternately, separating and then closing the elongated barrel 12 and the short barrel 14.

It will be readily apparent to persons skilled in the art that the bicycle seat adapter 68 of the present invention is operative to fix a bicycle seat 52 to a simple seatpost (i.e. a seatpost that is not also a pump). In other words, the bicycle seat adapter 68 can also be used to fix a bicycle seat 52 to a simple metal tube or other object that is used as a seatpost. Furthermore, the bicycle seat adapter 68 can be used to fix a bicycle seat 52 to a seatpost that is an integral part of the bicycle frame (i.e. a seatpost that cannot be removed from the bicycle frame). Rather than inserting a seatpost into the bicycle frame, as is done in the prior art, the seatpost would form part of the bike frame and would be inserted into the hollow seat tube 60 portion of the bicycle seat adapter 68. Therefore, the bicycle seat adapter 68 of the present invention can be used to fix a bicycle seat 52 to a seatpost element wherein the seatpost element can be a pump 10, a conventional seatpost, an integral part of the bicycle frame, or other object.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A bicycle seat adapter (68) for mounting a bicycle seat to a seatpost element of a bicycle, said bicycle seat adapter comprising a bicycle seat (52) coupled to a hollow seat tube (60), said hollow seat tube operative to receive therein an upper end of said seatpost element and having a clamp (66) operative to compress said hollow seat tube (60) about said seatpost element.

2. A bicycle seat adapter (68) according to claim 1, wherein an inside diameter of said hollow seat tube (60) is equal to an inside diameter of a hollow bicycle frame element (50), said hollow bicycle frame element operative to receive said seatpost element.

3. A bicycle seat adapter (68) according to claim 1, wherein said seatpost element is a bike pump (10) that fits into a hollow bicycle frame element (50).

4. A bicycle seat adapter of claim 1, wherein said clamp (66) is a quick release clamp.

5. A bicycle seat adapter of claim 1, wherein said bicycle seat is reversibly coupled to said hollow seat tube.
